(19) United States
(12) Patent Application Publication
(10) Pub. No.: US 2026/0328624 A1
(43) Pub. Date: Oct. 22, 2026

(54) OPTICAL PHASEMETER FOR INTERFEROMETRY

(71) Applicant: THE UNIVERSITY OF CHICAGO, Chicago, IL (US)

(72) Inventors: Sarah B. King, Chicago, IL (US); Nasim S. Mirzajani, Chicago, IL (US); Clare Keenan, Chicago, IL (US)

(21) Appl. No.: 19/104,700

(22) PCT Filed: Aug. 22, 2023
(86) PCT No.: PCT/US23/72632

§ 371 Date: Feb. 18, 2025

Related U.S. Application Data
(60) Provisional application No. 63/399,826, filed on Aug. 22, 2022.
(60) Provisional application No. 63/479,099, filed on Jan. 9, 2023.

(51) Int. Cl. G01J 9/02

(52) U.S. Cl. CPC G01J 9/02

(57) ABSTRACT

Interferometric measurement system includes light source generating a sample beam of light and local oscillator oscillating the sample beam to form an oscillated beam of light. System includes a mirror with a vibrating element causing the mirror to vibrate at a frequency, and receives the oscillated beam of light, modulates a phase of the oscillated beam of light. System includes a lock-in amplifier that is locked into the frequency of vibration of the mirror such that the lock-in amplifier receives the oscillated beam of light which has been modulated at the frequency. Processor detects a relative phase between the oscillated beam of light and the sample beam of light, an interference signal and correct a pathlength difference between the oscillated beam of light and the sample beam of light based at least in part on the relative phase, to correct for phase variation that occurs during a measurement.

### CROSS-REFERENCE TO RELATED APPLICATIONS

The present application claims the priority benefit of U.S. Provisional Patent App. No. 63/399,826 filed on Aug. 22, 2022 and U.S. Provisional Patent App. No. 63/479,099 filed on Jan. 9, 2023, the entire disclosures of which are incorporated by reference herein.

### BACKGROUND

Sum frequency generation (SFG) is a second-order non-linear optical technique that is a powerful tool for probing buried interfaces by taking advantage of the symmetry properties of the complex second-order nonlinear susceptibility χ⁽²⁾. The ubiquity and importance of interfaces in chemistry makes SFG a very attractive method due to its all-optical, non-invasive nature. It has found prominence with vibrational studies in particular, for determining structure and orientation of interfacial molecules. However, despite its tremendous potential, SFG spectroscopy has yet to become a widespread technique for the study of interfacial electronic structure and dynamics. Notably, experiments that require repeated spectral acquisitions over varying sample properties, such as time-resolved experiments, have proven uncommonly challenging.

### SUMMARY

An illustrative interferometric measurement system includes a light source that generates a sample beam of light and a local oscillator that oscillates a portion of the sample beam of light to form an oscillated beam of light. The system includes a mirror that includes a vibrating element which causes the mirror to vibrate at a frequency, where the mirror receives the oscillated beam of light and modulates a phase of the oscillated beam of light. The system includes a lock-in amplifier that is locked into the frequency of vibration of the mirror such that the lock-in amplifier receives the oscillated beam of light which has been modulated at the frequency. A processor is in communication with one or more of the light source, the local oscillator, and the lock-in amplifier, and is configured to detect, based at least in part on data from the lock-in amplifier, a relative phase between the oscillated beam of light and the sample beam of light. The processor is also configured to detect an interference signal and correct a pathlength difference between the oscillated beam of light and the sample beam of light based at least in part on the relative phase. The processor is further configured to apply the corrected pathlength difference to the interference signal to correct for phase variation that occurs during a measurement.

An illustrative method for performing interferometric measurements includes generating, by a light source, a sample beam of light. The method includes oscillating, by a local oscillator, a portion of the sample beam of light to form an oscillated beam of light. The method includes vibrating, at a frequency, a mirror that receives the oscillated beam of light to modulate a phase of the oscillated beam of light. The method includes receiving, by a lock-in amplifier that is locked into the frequency of vibration of the mirror, the oscillated beam of light which has been modulated at the frequency. The method includes detecting, by a processor and based at least in part on data from the lock-in amplifier, a relative phase between the oscillated beam of light and the sample beam of light. The method also includes detecting, by the processor, an interference signal. The method also includes correcting, by the processor, a pathlength difference between the oscillated beam of light and the sample beam of light based at least in part on the relative phase. The method further includes applying, by the processor, the corrected pathlength difference to the interference signal to correct for phase variation that occurs during a measurement.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 is a simple schematic of a Mach-Zehnder interferometer (MZI) set up for continuous phase modulation in accordance with an illustrative embodiment.

FIG. 2 depicts modulations in the interference between two fields of a spectrometer in accordance with an illustrative embodiment.

FIG. 3 depicts an experimental schematic of the proposed MZI in accordance with an illustrative embodiment.

FIG. 4A shows a CW diode signal locked into the second harmonic of mirror vibration frequency in accordance with an illustrative embodiment.

FIG. 4B shows a CW diode signal locked into the third harmonic of the mirror vibration frequency in accordance with an illustrative embodiment.

FIG. 4C shows the SFG signal locked into the first harmonic of the mirror vibration frequency in accordance with an illustrative embodiment.

FIG. 5A shows the measured value of Δφ plotted against the original time delay axis in accordance with an illustrative embodiment.

FIG. 5B shows Δφ plotted against the reconstructed delay axis in accordance with an illustrative embodiment.

FIG. 5C shows the difference between the original axis plotted and the new axis, plotted against the new axis in accordance with an illustrative embodiment.

FIG. 5D shows the drift in path length over the full length of the scan in accordance with an illustrative embodiment.

FIG. 6A shows a Fourier transform of (a) the raw diode data showing the frequency of the diode at 1.89 eV in accordance with an illustrative embodiment.

FIG. 6B depicts frequency domain GaAs spectra showing three peaks at 2.92 eV (second harmonic of 850 nm fundamental), 3.54 eV (SFG of 850 nm and 600 nm), and 4.09 eV (second harmonic of 600 nm) in accordance with an illustrative embodiment.

FIG. 6C. shows a non-uniform Fourier transform of the phase corrected data from FIG. 6A showing narrower peaks with less noise and higher intensity in accordance with an illustrative embodiment.

FIG. 6D. shows a non-uniform Fourier transform of the phase corrected data from FIG. 6B showing narrower peaks with less noise and higher intensity in accordance with an illustrative embodiment.

FIG. 7 shows Bessel function values as a function of mirror modulation amplitude for various relevant wavelengths in accordance with an illustrative embodiment.

FIG. 8 shows the reported position of the piezo of the vibrating mirror as a function of time, determined using capacitive sensing in accordance with an illustrative embodiment.

FIG. 9A depicts raw spectra data obtained at different fundamental wavelengths in accordance with an illustrative embodiment.

FIG. 9B depicts corrected spectra data obtained at different fundamental wavelengths in accordance with an illustrative embodiment.

FIG. 10A depicts raw spectra data from z-cut quartz in the sample position and GaAs as the LO source in accordance with an illustrative embodiment.

FIG. 10B depicts corrected spectra data from z-cut quartz in the sample position and GaAs as the LO source in accordance with an illustrative embodiment.

FIG. 11A shows spectra corresponding to FIG. 6D collected with a traditional frequency domain spectrometer in accordance with an illustrative embodiment.

FIG. 11B shows spectra corresponding to FIG. 10 collected with a traditional frequency domain spectrometer in accordance with an illustrative embodiment.

FIG. 11C shows spectra corresponding to FIG. 9 collected with a traditional frequency domain spectrometer in accordance with an illustrative embodiment.

FIG. 12 is a block diagram of a computing system to implement a phase correction system in accordance with an illustrative embodiment.

FIG. 13 depicts a system that utilizes a broadband white light probe in accordance with an illustrative embodiment.

FIG. 14 shows proof of principle experiment results for phase correction with the chopper and two lock in amplifier scheme of FIG. 13 in accordance with an illustrative embodiment.

FIG. 15 shows a comparison of the two schemes with broadband light in accordance with an illustrative embodiment.

### DETAILED DESCRIPTION

Heterodyne detection sum frequency generation (HD_SFG) spectrometers are used to separate and measure various spectral components of an object with great accuracy. Sum frequency generation (SFG) is a second-order non-linear optical technique that has found application as a powerful tool for probing buried interfaces by taking advantage of the symmetry properties of the complex second-order nonlinear susceptibility χ(2). In broadband electronic SFG (e-SFG), a broadband pulse EVis(ω1) is temporally and spatially overlapped with a narrowband infrared pulse ENIR(ω2). The interaction of the pulses with the system susceptibility χ(2) results in the SFG signal ESFG(ω1+2) radiated at the sum frequency. The response of the system χ(2) is encoded within the detected SFG field ESFG(ω1+2) and has all the spectroscopic information that is of interest to scientists.

Heterodyne detection is often used to detect the phase of the emitted ESFG(ω1+2) field, encompassing a wealth of information without which the data about χ(2) is distorted, as well as to boost the signal to noise ratio. Heterodyne detection is an interference measurement where a strong, known field, called the local oscillator (LO) mixes with the SFG signal. Generally, in interferometry light from two or more sources are merged (i.e. the light waves are superimposed) to create an interference pattern that contains information on the frequency and temporal profile of the light waves. For experiments that are detected in the time domain, the interference pattern is created by changing the path length of one light wave with respect to the other, and so changing their relative phase, over the length of a scan. To interpret the data correctly, the relative phase between the waves must be known at all times. In traditional systems, the relative phase is experimentally controlled by scanning a mechanical stage that extends or shortens the pathlength that one of the light waves travels. For experiments that are detected in the frequency domain, the pathlength difference and therefore the relative phase of the two light waves is held constant, but must remain a known and constant quantity.

However, ambient laboratory vibrations tend to introduce slow drifts in the optics, compromising the stability of the set up by introducing small errors in the optical path length. Thus, the relative phase between the light waves is no longer proportional to the experimentally controlled mechanical stage that sets the pathlength difference in time domain experiments. In frequency domain experiments, this means that the relative phase is not the known constant it was set to by the experimenter but drifting over the length of the experiment. This compromises the fidelity of the interference data.

Phase stability between the SFG signal and the local oscillator in such experiments is critical for obtaining an accurate signal. Traditional heterodyne detection sum frequency generation (HD_SFG) spectrometers rely on passive phase stabilization techniques where phase stability between local oscillator (LO) and SFG fields is achieved by implementing collinear geometries where the LO and SFG beams are incident on the same optics and thus experience pathlength drift by the same amount. Passive stabilization does not ensure stability over long periods of time and is not suitable for extended time-resolved studies. Phase instability results in distorted data and low signal to noise ratio (SNR). For SFG signals which are inherently weak and difficult to detect, phase instability is detrimental. Some active stabilization techniques have been used in other areas of spectroscopy (such as 2D IR spectroscopy) where phase drift is detected and a closed-loop feedback circuit is used to undo the path length difference arising from drift in the optics by readjusting the position of a mechanical stage. However such a scheme is expensive, time-consuming and difficult to carry out.

Described herein is a system to improve the accuracy and efficiency of interferometry measurements by more accurately accounting phase variations that occur during a measurement. There are several components to this technology that will be explained in detail. In an illustrative embodiment, the proposed system is a spectrometer that uses sum frequency generation (SFG) to unravel chemical properties of matter in buried interfaces. The spectrometer enables phase-sensitive measurements by using heterodyne detection (HD), and the design of the spectrometer ensures that instabilities in the optical set-up of the spectrometer do not compromise the fidelity of the detected data. An important aspect of this spectrometer is in the functional design of the third point: ensuring phase stability for heterodyne detected SFG (HD-SFG) data over long periods of time. This ensures high-quality high-fidelity data from buried interfaces for lengthy experiments such as time-resolved studies that elucidate the dynamics of molecules at interfaces.

The proposed spectrometer design ensures that the system is not reliant on knowledge of optical pathlength difference between the LO and SFG fields alone for the relative phase. The relative phase is obtained directly through signal processing based on the underlying physics behind the design of the experimental set up. In an illustrative embodiment, the system uses continuous phase modulation of the local oscillator field to expand the interference signal in terms of its Fourier coefficients, which allows one to obtain the relative phase between the LO and the SFG field. Continuous phase modulation of the LO field is achieved by reflecting the LO beam off a mirror connected to a vibrating element. A lock-in amplifier is used to detect the interference signal locked into the harmonics of the mirror vibrations frequency.

In one embodiment, the optical scheme can be as follows: the SFG and the LO fields make up two arms of a Mach-Zehnder interferometer. A continuous wave (CW) reference beam from a diode laser at 660 nm, with the opposite polarization to the pulsed laser beams, travels collinearly with each arm. The sample arm enters a delay line with a computer-controlled delay stage and the LO line is sent to a retroreflector fitted with a piezo phase shifter, vibrating the retroreflector at 800 Hz. The two arms are then recombined and go through a series of dichroic mirrors to separate the UV SFG beams from the visible and near IR fundamental beams as well as the CW beam. Alternatively, different frequencies may be used.

Separate avalanche photodiode (APD) detectors can be used to detect the SFG signal and the CW reference beam. The detectors are fed into a lock-in amplifier (e.g., Zurich Instruments MFLI) that is locked into the frequency of the vibrations such that only signal that is modulated by that frequency is detected. The inventors have written software that processes the data from the lock-in amplifier to detect the relative phase between the LO and SFG fields, detect the interference signal, correct the pathlength difference between the LO and SFG based on their relative phase and apply the corrected pathlength difference to the interference signal.

More specifically, described herein is an interferometric design for a phase-sensitive electronic sum frequency generation (e-SFG) spectrometer where continuous phase modulation of one arm of the interferometer affords direct measurement of the phase between SFG and LO fields. Errors in the path length difference caused by drifts in the optics are corrected using the measured phase, offering unprecedented stability. In an illustrative embodiment, a vibrating mirror is used to modulate interference. Specifically, the mirror vibrates at a known frequency (vᵣ) at each time delay, and the vibration induces modulations in the interferogram. The change in phase is measured at each time delay using a narrowband diode laser as a proxy.

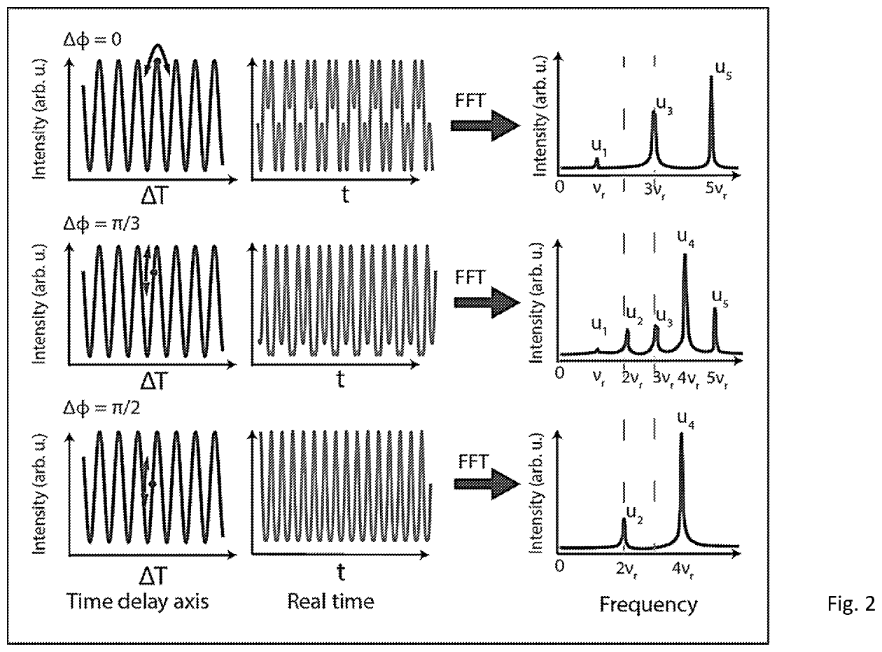

Fourier transforms of the induced modulations yield peaks at harmonics of the modulating frequency vᵣ. The peak intensities vary with the phase, as shown in the rightmost plots of FIG. 2, which is described in more detail below. In an illustrative embodiment, a lock-in amplifier is used to measure the peak intensities at the harmonics. These modulations encode relative phase, which is used to determine and account for drift. Specifically, measured ΔΦ shows drifts and inconsistencies throughout a scan, and this information is used to recalculate the time delay axis. An axis correction is then applied to SFG time domain data to correct for the phase instability. The capabilities of the spectrometer are demonstrated with proof-of-principle experiments with GaAs SFG spectra, where one can see significantly improved SNR, spectral accuracy, and lineshapes.

As discussed above, sum frequency generation (SFG) is a second-order non-linear optical technique that is a powerful tool for probing buried interfaces by taking advantage of the symmetry properties of the complex second-order nonlinear susceptibility χ⁽²⁾. In broadband electronic SFG (e-SFG), a broadband pulse E_{Vis}(ω₁) is temporally and spatially overlapped with a narrowband near-infrared pulse E_{NIR}(ω₂). The interaction of the pulses with the system susceptibility χ⁽²⁾ results in the SFG signal ESFG (ω₁₊₂) radiated at the sum frequency in the ultraviolet region, as described by Equation (1) below:

E_{SFG}(ω₁₊₂)=χ²:E_{Vis}(ω₁)E_{NIR}(ω₂) Equation 1:

Conventional SFG experiments measure the intensity I of the SFG light, which is proportional to the square modulus of the SFG electric field, |E_{SFG}|². With proper normalization against a nonresonant reference, |χ⁽²⁾|² can be extracted from |E_{SFG}|². There are several disadvantages to measuring |χ⁽²⁾|² as opposed to χ⁽²⁾. First, with the loss of phase information in |χ⁽²⁾|², interpreting resonances becomes difficult because χ⁽²⁾ is a linear combination of complex contributions, each with their own phase and amplitude. Nonresonant contributions are in the real portion of χ⁽²⁾, while the imaginary part of χ⁽²⁾ contains the desired spectroscopic resonances of the system. Interference between multiple resonances as well as between resonant and nonresonant contributions in |χ⁽²⁾|² means that frequencies are shifted from their true values, line shapes are distorted, and separating resonant and nonresonant signals becomes impossible. Second, information on the sign of the electric field is lost in intensity measurements. The sign of the electric field is related to the orientation of the oscillating dipoles that originate the coherent signal and can yield the “up” or “down” orientation of the interfacial molecules. Third, the term |χ⁽²⁾|² is proportional to the square of the density of interfacial molecules and not conducive to quantitative spectrometric experiments where intensity is expected to be proportional to sample concentration or density. Fourth, in time-resolved experiments, spectra are acquired alternately with and without the presence of the pump pulse at each time delay. The unpumped (steady-state) spectrum is subtracted from the pumped spectrum to obtain ΔE_{SFG}. To correctly interpret time-resolved data from Δ|E_{SFG}|² requires extensive fitting analysis whereas directly measuring ΔE_{SFG} makes data analysis straightforward. It has also been suggested that pump-induced phase shifts occur in the SFG signal which can only be detected with a phase-sensitive approach.

Phase-sensitive (PS) experiments provide a solution to these problems by detecting E_{SFG} rather than |E_{SFG}|². Heterodyne detection is a phase-sensitive measurement where the interference between the SFG field and a local oscillator (LO) field is measured. The LO is generated separately from the SFG using the same incident fields E_{Vis} and EIR and contains the same frequencies as the SFG field. The interference with LO generates both |E_{SFG}|² and |E_{LO}|² as well as a cross term (|E_{SFG}|²+E_{LO}*E_{SFG}+E_{LO}E_{SFG}*), shown below in Equation (2), where E_{LO} and E_{SFG} are complex fields that contain frequency and phase information. The cross term is not a square modulus and can access the complex values of the electric fields.

I=|E_{SFG}+E_{LO}|²=|E_{LO}|²+|E_{SFG}|²+E_{LO}*E_{SFG}+E_{LO}E_{SFG}* Equation 2:

Thus heterodyne detection enables the separation of real and imaginary parts of χ⁽²⁾ and the measurement of the sign of the electric field. Since the LO is a much stronger signal than the SFG, mixing the two also increases the signal to noise ratio (SNR). However, as an interference-based measurement, obtaining correct signals in heterodyne detection hinges on phase stability between the LO and SFG fields throughout the experiment. This presents a challenging technical hurdle that is particularly highlighted in the case of electronic SFG experiments that generate visible and UV light. At these wavelengths, drifts of tens of nanometers in the relative path lengths between the SFG and LO fields lead to dramatic phase shifts of as much as π/4. Small errors in the optical path length caused by, for example, ambient laboratory vibrations and thermal fluctuations compromise the stability of the interferometer, making detection of heterodyned SFG signal difficult.

Most phase-sensitive SFG methods respond to the problem of stability by employing passive phase stabilization. Many vibrational and almost all electronic SFG studies use spectral interferometry of collinear LO and SFG pulses detected in frequency domain to measure phase of the SFG signal. In a collinear geometry, the LO and SFG light experience similar path length drift by impinging on the same optics, facilitating passive phase stabilization. However, for extended time-resolved studies of electronic spectra, passive phase stabilization is not sufficient to eliminate uncertainty in phase and amplitude between time delay measurements. Phase instability is the main barrier to performing heterodyned time-resolved electronic SFG experiments. Additionally, the relative height of the sample and the reference must remain the same to micron accuracy for every measurement to ensure correct measurement of the phase of χ⁽²⁾. This is cumbersome, particularly in the case of liquid interfaces which may undergo evaporation during the experiment.

The need for control and stability of relative phases between pulse pairs is not unique to heterodyne detection in SFG experiments. Stable phase-locked pulse pairs are used in many nonlinear spectroscopic techniques where phase cycling is used for selective detection of quantum pathways. To address phase stability issues, many techniques have been introduced including active stabilization methods using closed-loop feedback circuits, passive stabilization using diffractive optics, and acousto-optic pulse shaping. In one system, phase-modulation using acousto-optic modulators (AOM) was applied to detection of 2D fluorescence and photocurrent spectroscopy. It has since become a popular method for dynamic rephasing in 2D electronic spectroscopy. Phase modulation with a vibrating mirror has also been used in pseudo-heterodyning in scanning near-field optical microscopy (SNOM) to acquire background suppression and simultaneous measurement of phase and amplitude of near-field images.

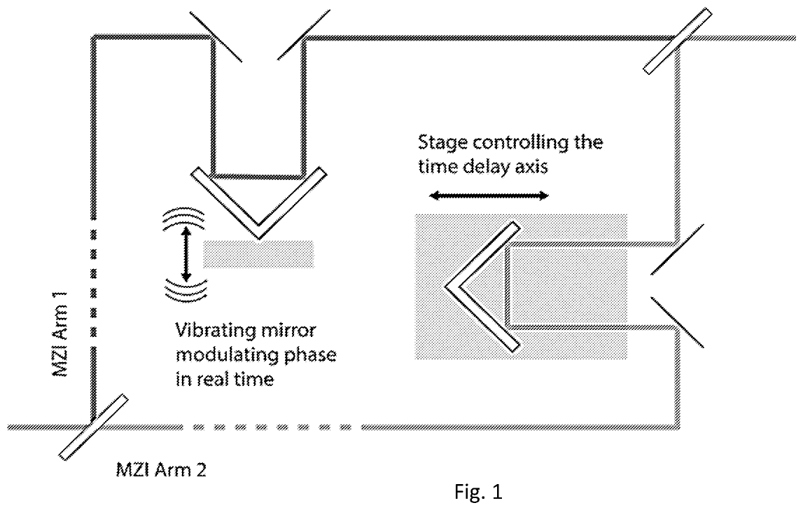

Described herein is a technique for directly reading the relative phase between SFG and LO fields using continuous phase modulation of the LO pulse with a vibrating mirror. This proposed technique allows the spectrometer to function in the time domain where the intensity of the interference of the two fields is detected as a function of varying relative time delay. FIG. 1 is a simple schematic of a Mach-Zehnder interferometer (MZI) set up for continuous phase modulation in accordance with an illustrative embodiment. This simplified schematic shows the time delay axis control with the stage in one arm, and real time phase modulation with a vibrating mirror in the other arm. The time delay between two interferometer arms is experimentally set by changing the optical path length difference between the LO and SFG fields, but is beset by instabilities in the optics. In contrast to active stabilization where the phase modulation information is used in a feedback loop to correct phase in real time, the proposed system collects the relative phase data and corrects for all instabilities at once in post-processing. A direct report of the relative phase between the LO and SFG fields allows one to reconstruct the time delay axis to account for unintended changes in the path length.

In addition to control over the phase stability of the interference signal, there are further advantages to interferometry in the time domain over spectral interferometry which necessarily occurs in the frequency domain. While frequency domain and time domain detection theoretically offer equivalent information, it has been shown that experimental considerations affect the measured spectra in frequency domain, particularly for vibrational spectroscopy, with significant implications for spectral lineshapes. Moreover frequency narrowing significantly reduces signal strength which decreases quadratically with pulse duration. Combined with reduced sensitivity in frequency domain detectors, loss in signal strength makes detecting small changes in the interfacial spectrum very difficult. To date, time domain detection of heterodyne SFG has only been performed for vibrational spectra with passive phase stabilization. The proposed spectrometer design paves the way for phase stable time domain detection of heterodyne SFG spectra, eliminating the above mentioned concerns for vibrational spectra, while allowing electronic spectra to benefit from the advantages of single channel detectors with higher sensitivity, lower noise, and lower costs than frequency domain detectors. Achieving phase stability over extended periods will make time-resolved studies with long experiment run-times possible for investigating both electronic and vibrational interfacial states.

Described below is the theory behind the proposed system. As discussed above, the SFG and LO fields each form one arm of a Mach-Zehnder interferometer (MZI). A time varying phase shift is applied to the LO field by reflecting the LO off a vibrating mirror, as shown in FIG. 1.

Mathematical description of the underlying optics described herein best explains the signal processing scheme. For convenience, the electric fields comprising the arms of the MZI are labeled with subscripts “1” and “2”. The discussion of these fields is general and can describe any two laser light waves, pulsed or continuous, that are set up as two arms of a MZI.

The intensity of two overlapped fields is expressed as:

I=|E₁e^{i(w}^{₁}^{t+φ}^{₁}⁾+E₂e^{i(w}^{₂}^{t+φ}^{₂}⁾|² Equation 3:

The vibrating mirror introduces an experimentally controlled additive phase, shown in Equation (4), to the E₁ field:

ζ(t)=γ cos νᵣt, Equation 4:

where γ is the phase amplitude and depends on the wavelength of light (λ) and the modulation depth of the vibrating mirror (ΔL) through the relationship

$$γ = \frac{4 πΔ L}{λ} .$$

One now rewrite the phase-modulated field as:

E₁(t)=E₁e^{iζ(t)}e^{i(w}^{₁}^{t+φ}^{₁}⁾. Equation 5:

A Jacobi-Anger expansion allows for a Fourier representation of the sinusoidal frequency modulated signal as a sum of harmonic components weighted by Bessel functions of varying order. Expanding Equation (5) in this manner leads to the following expression for the phase-modulated field:

$${E}_{1} {\sum }_{m = - ∞}^{∞} {J}_{m} [ γ ] {e}^{\frac{i m π}{2}} {e}^{i ( {w}_{1} t + {ϕ}_{1} )} , \qquad Equation 6$$

where Jₘ[γ] is the mth order Bessel function evaluated at γ. A detailed derivation is described in detail below. The detected intensity for the interference of the two fields is now:

$$I = {\vert {E}_{1} {e}^{i ζ ( t )} {e}^{( {w}_{1} t + {ϕ}_{1} )} + {E}_{2} {e}^{( {w}_{2} t + {ϕ}_{2} )} \vert}^{2} = {\vert {E}_{1} ( {\sum }_{m = - ∞}^{∞} {J}_{m} [ γ ] {e}^{\frac{tm π}{2}} {e}^{i ( {w}_{1} t + {ϕ}_{1} )} ) + {E}_{2} {e}^{( {w}_{2} t + {ϕ}_{2} )} \vert}^{2} \qquad Equation 7$$

At each time delay, E₁ is modulated in real time by the vibrating mirror. This yields a modulation in the interference between the two fields that depends on their relative phase Δφ. FIG. 2 depicts modulations in the interference between two fields of a spectrometer in accordance with an illustrative embodiment. In FIG. 2, the upper row depicts relative phase of 0, the middle row depicts relative phase of pi/3, and the bottom row depicts relative phase of pi/2. In each row, the leftmost trace is a cartoon of the unmodulated interferogram, where the dots indicate the point in time delay marked by the relative phase of the two arms, Δφ, and the arrows indicate how the vibrating mirror modulates the interferogram intensity. The middle trace in each row shows the result of the modulation at various time delays (i.e., the interference pattern in real time due to vibrations of the mirror in one arm of the interferogram) indicated by the dots. The expansion of this signal into its Fourier series yields the series of peaks at harmonics m of the frequency νᵣ, shown in the rightmost plots of FIG. 2. The intensity of the peak at the mth harmonic of the modulation frequency is denoted as Uₘ. The intensities of the even and odd harmonic peaks change with the value of Δφ. For the in-phase signal where Δφ=0, even side bands go to zero (i.e. Uₘ₌ₑᵥₑₙ=0) and for the quadrature signal where Δφ=π/2, odd side bands go to zero.

The values of Uₘ are obtained by expanding Equation (7), isolating the cross terms, and finding their Fourier expansion coefficients. Experimentally, a lock-in amplifier locked into a harmonic frequency mvᵣ multiplies the interference signal in Equation (7) with a field e^{-i(mν}^{ᵣ}^{t)}, effectively picking the term of the Fourier series at harmonic m. Locking into the modulations of one interferometer arm also ensures that only signal containing that modulation frequency is detected and any noise from the baseline arising from |E₁|² and |E₁|² is suppressed. Equation (8) shows the mathematical expression of the side-band intensities Uₘ as detected by the lock-in amplifier.

$${U}_{m} = 2 {E}_{1} {E}_{2} {J}_{m} [ γ ] cos ( Δ ϕ - \frac{m π}{2} ) \qquad Equation 8$$

As shown in Equation (8), the intensity of each side-band has a sinusoidal dependence on the phase difference between the two fields, given by Δφ=φ₁−φ₂. Successive even and odd side-bands are respectively proportional to the real (cos) and imaginary (sin) components of the complex cross-term of the interference signal, where ω₁=ω₂. This relationship is shown in Equation (9).

$$Equation 9$$

$$\begin{matrix}\frac{{U}_{2}}{{J}_{2} [ γ ]} + \frac{{U}_{3}}{{J}_{3} [ γ ]} = \frac{2 {E}_{1} {E}_{2} {J}_{2} [ γ ] cos ( Δϕ - \frac{π}{2} )}{{J}_{2} [ γ ]} + \frac{2 {E}_{1} {E}_{2} {J}_{3} [ γ ] cos ( Δ ϕ - π )}{{J}_{3} [ γ ]} \\ = 2 {E}_{1} {E}_{2} ( cos Δϕ + i sin Δϕ ) \\ = {E}_{1} {E}_{2} {e}^{i Δ ϕ}\end{matrix}$$

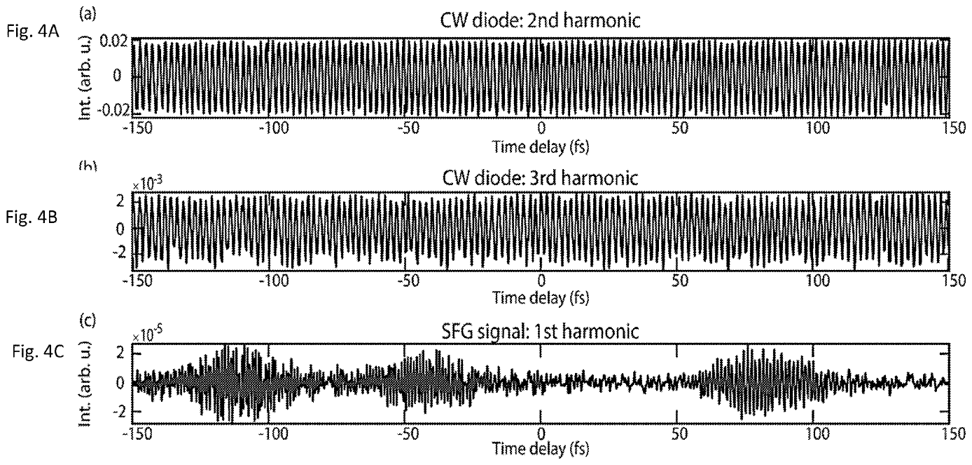

Equations (8) and (9) show the dependence of Uₘ on Δφ and its relationship to the interference of the E₁ and E₂ fields. The detected Uₘ signals (shown in FIG. 4, which is described in more detail below), are a periodic function of Δφ, as shown in Equation 8. Thus the Uₘ signal in FIG. 4 may be treated as an interferogram whose Fourier transform is the frequency domain spectrum of the shared frequencies in E₁ and E₂ fields. This implies that the Uₘ signal detected as a function of time delay can be used to find the frequencies present in SFG and LO fields.

Relative phase Δφ can be calculated from the ratio of intensity of two consecutive odd and even side bands as shown in Equation (10) where Jₖ and Jₗ are k (odd) and l (even) order Bessel functions:

$$Δ ϕ = \pm arctan \frac{{U}_{det , l} {J}_{K} [ γ ]}{{U}_{det , k} {J}_{l} [ γ ]} \qquad Equation 10$$

For the case of broadband light where E_{SFG} and E_{LO} have finite bandwidth, a simplified expression describing the fields is a sum over the number n of colors present, shown in Equation (11):

E_{SFG}=ΣᵢⁿE_{SFG},i e^{ω}^{ᵢ}^{tφ}^{ᵢ} Equation 11:

This expression is substituted for the electric fields in Equation (7), with each color having a different relative phase. In solving the equation for intensity, Equation (8) becomes a sum over the number n of colors present:

$${U}_{det} = {\sum }_{i}^{n} 2 ( {E}_{LO , i} {E}_{SFG , i} ) {J}_{m} [ {γ}_{i} ] cos ( Δ ϕ - \frac{m π}{2} ) \qquad Equation 12$$

Equation (10) for the broadband fields becomes:

$$\frac{{U}_{det , l}}{{U}_{det , k}} = \frac{{\sum }_{i}^{n} {J}_{l} [ {γ}_{i} ] sin {Δϕ}_{i}}{{\sum }_{i}^{n} {J}_{k} [ {γ}_{i} ] cos {Δϕ}_{i}} \qquad Equation 13$$

Equation (13) is analytically intractable. Since the real source of phase instability is in path length difference, which unlike phase, is color-independent, a narrowband reference can be used for the purpose of phase detection. The inventors therefore co-propagate a narrowband continuous wave (CW) laser diode with the E_{SFG} and E_{LO} fields, to be used for detecting the relative phase of the arms of the MZI. This is a valid approach given the generality of the signal processing procedure detailed above for any light analyzed by interferometry. The frequency spectrum of the CW laser is closer to a delta function than the frequency spectra of ultrashort laser pulses are, giving a more accurate value for the phase difference between the two arms that can be converted to a path length difference.

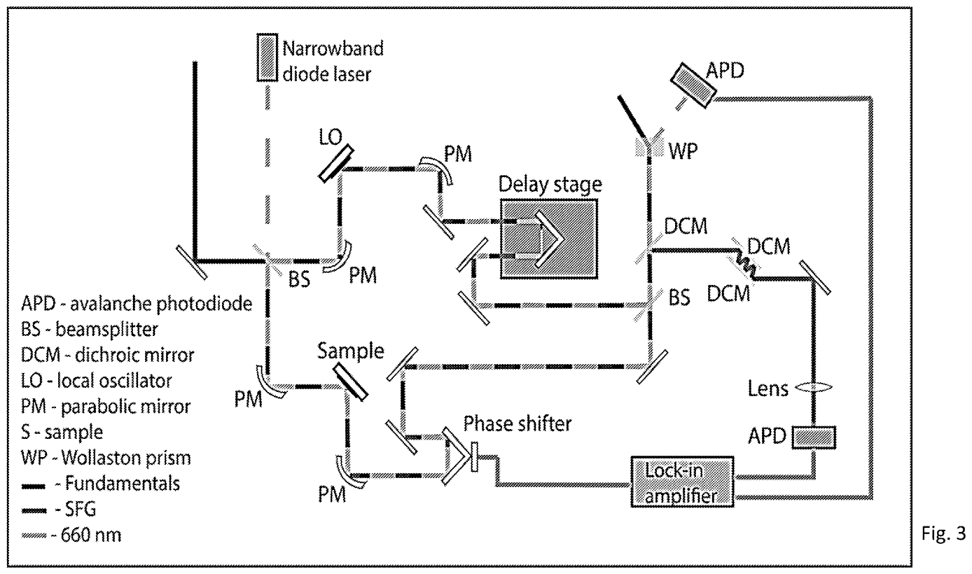

Described below are various systems and components that can be used to implement the proposed system. In one embodiment, visible and near infrared up-conversion pulses are generated by a commercial OPA system (e.g., Light Conversion Orpheus N-2H and N-3H) with two outputs at 600 nm (150 mW) and 850 nm (500 mW), with sub 30 fs pulse duration at 50 kHz repetition rate. Alternatively, different output values may be used. Both fields are P-polarized. The two pulses at 600 nm and 850 nm are made collinear using an in-coupling dichroic mirror (e.g., Thorlabs) before they enter a Mach-Zehnder type interferometer. A 50/50 broadband, low GDD beamsplitter (e.g., Thorlabs) is used to split the overlapped beams into two arms. Separately, a narrowband CW laser (e.g., Newport LQC660-110C) at 660 nm with the opposite polarization to the pulsed laser light is also incident the beam-splitter at 90 degrees to the pulsed laser light, as shown in FIG. 3, such that it travels collinearly with the pulsed light into the interferometer.

FIG. 3 depicts an experimental schematic of the proposed MZI in accordance with an illustrative embodiment. The path of the collinear beams is shown as they enter the interferometer and are incident on the LO and sample crystals, with shaded dashes to depict the signals on each line. As shown, a fundamental signal into the system is split by a beamsplitter and directed by parabolic mirrors to the sample and a local oscillator. Also shown is the SFG signal. A narrowband diode laser used to measure the phase difference between the interferometer arms is also shown, travelling collinearly with the SFG and LO beams throughout the MZI.

Each arm is focused by a parabolic mirror onto a sample or local oscillator source, in reflection geometry, and is subsequently recollimated along with the resulting SFG, where one arm of the interferometer contains the sample signal and the other functions as the local oscillator field. The LO arm enters a delay line with a computer controlled delay stage (e.g., PI N565) and the sample line is sent to a retroreflector fitted with a piezo phase shifter (e.g., PI S-303), vibrating the retroreflector at 800 Hz. The two arms are then recombined using a low GDD beam splitter (e.g., Thorlabs).

The recombined beams then go through a series of dichroic mirrors (e.g., Eksma) to separate the UV SFG signal from the visible and near IR fundamental fields as well as the CW laser. The SFG signal is directed towards the first avalanche photodiode (e.g., Thorlabs APD 130A2). The CW diode has a perpendicular polarization relative to the fundamentals and is separated from them using a Wollaston prism and is directed towards a second avalanche photodiode (e.g., Thorlabs APD 130A). The photodiode outputs are passed to a lock-in amplifier (e.g., Zurich Instruments MFLI) that also serves as the signal source for the phase shifter. The lock-in amplifier is simultaneously locked into multiple harmonics of the frequency of the vibrations. It is noted that the proof-of-concept experiments that showcase the capabilities of this spectrometer use SFG spectra of a GaAs(100) single crystal purchased from MTI corp.

In an illustrative embodiment, three channels on the lock-in amplifier are used for data collection. The CW laser signal from the second APD is the input for the first two channels, each locked into the second or third harmonics of the vibrations of the phase shifter. The third channel input is the SFG signal from the first APD and is locked into the first harmonic of the phase shifter frequency. FIG. 4 depicts time domain data collected on the three locked-in signals received by the lock-in amplifier in accordance with an illustrative embodiment. FIG. 4A shows a CW diode signal locked into the second harmonic of mirror vibration frequency in accordance with an illustrative embodiment. FIG. 4B shows a CW diode signal locked into the third harmonic of the mirror vibration frequency in accordance with an illustrative embodiment. These intensities are the Um values used for detecting relative phase between the two arms of the MZI. FIG. 4C shows the SFG signal locked into the first harmonic of the mirror vibration frequency in accordance with an illustrative embodiment. As discussed, the CW signals are used for determining the phase difference between the two arms of the MZI.

As previously mentioned, the CW diode beam is divided and co-propagated with both the LO and the SFG fields, and is subjected to the same treatments. The phase modulation of the LO arm by the phase-shifter results in modulation of the interference signal. The lock-in amplifier detects the intensity Uₘ of harmonic m of the phase modulated signal in real-time for every time delay between the two arms of the MZI. For this experiment, two channels on the lock-in amplifier were locked into the second and third harmonics of the reference frequency, νᵣ, which is also used as the frequency of the phase-shifter. These channels receive signal from the APD detecting the CW diode beam and are depicted in FIGS. 4A and 4B. A third channel is locked into the first harmonic of νᵣ and detects the pulsed SFG signal, shown in FIG. 4C.

Given that the time dependent signal is described by Equation (8), the value of the Bessel function modulates the signal intensity. The Bessel function value J[γ] depends on the wavelengths of light (λ) present in the SFG light, the value of the integer m, and the vibration depth (ΔL) of the phase shifter. Judicious selection of the harmonic of the lock-in reference frequency and vibration depth of the phase shifter can increase the signal to noise ratio as well as eliminate unwanted fundamental wavelengths on the detector.

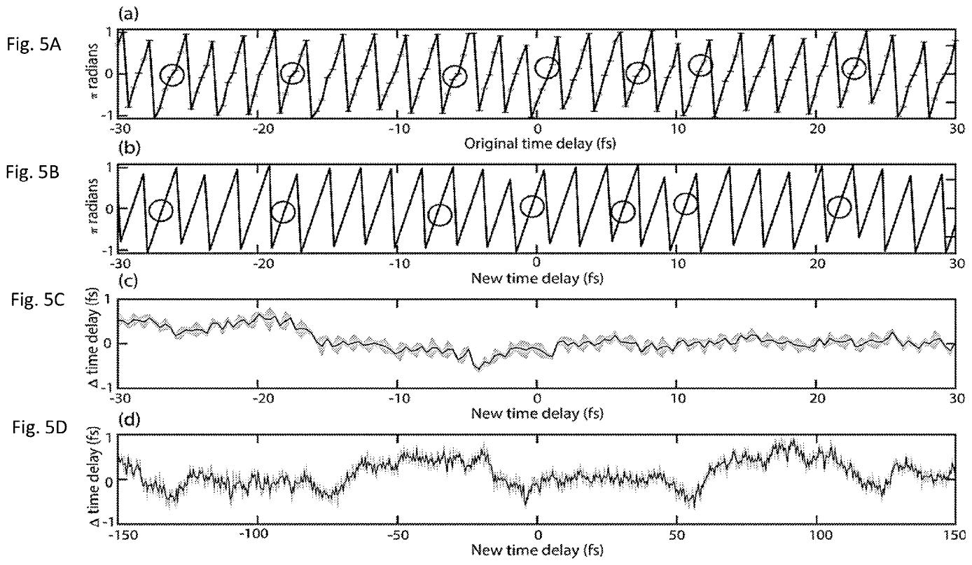

The ratio of the intensities U₂ and U₃, shown in FIGS. 4A and 4B respectively, are obtained at each time delay. From this ratio, the phase difference at each point in the time delay axis is obtained according to Equation (10) and is shown in FIG. 5A. This corresponds to the conceptual drawing in FIG. 2, where Δφ in each row can be obtained from the ratio of U₂ and U₃ intensities shown on the rightmost trace.

FIG. 5A shows the measured value of Δφ plotted against the original time delay axis in accordance with an illustrative embodiment. Given a high sampling rate and stable conditions, this plot should be a perfect saw-tooth shape, as phase changes from −π to π for each period of the wavelength. Instabilities in phase can be seen in the form of ‘kinks’ in the plot in FIG. 5A, which are circled. The small lines in FIG. 5A show error boundaries for Δφ values. It is noted that the error is too small at some points to distinguish the upper and lower bounds in the figure. The kinks disappear from the plot when phase is plotted against a time delay axis that corresponds to the true phase difference. To achieve this, the inventors recreated the time delay axis using the measured Δφ values.

The direct proportionality relationship linking time delay between two pulses and their path length difference is well-known. One can replace the original time delay axis which was based on the reported displacement of the mechanical stage in the interferometer with a new computed time delay axis based on the detected Δφ. The relative phase of two pulses is a direct reporter of their temporal delay with respect to each other and therefore a reporter of their path length difference. However, where phase is a periodic function of the wavelength, the path length difference between the two pulses is a monotonic function. Phase difference Δφ can be used to calculate path length difference Δx as a fraction of the wavelength for the first period, with subsequent periods added in series, as shown in Equation (14). The value of n, denoting the climbing number of periods, increases by 1 every time Δφ completes a 2π cycle. The new delay axis is thus constructed based on the computed phase difference between the two interferometer arms.

$$Δ x = Δ ϕ \frac{λ}{2 π} + n λ \qquad Equation 14$$

FIG. 5B shows Δφ plotted against the reconstructed delay axis in accordance with an illustrative embodiment. The points on the scan where phase instabilities had occurred, circled, now present a smooth trace.

The original axis only accounts for path length differences due to scanning the stage and is informed only by the stage controller. However, the new time delay axis accounts for path length differences due to scanning the stage as well as those that are due to instabilities caused by slowly drifting optics. It also accounts for errors in reported stage positions. This is reflected in FIGS. 5C and 5D. FIG. 5C shows the difference between the original axis plotted and the new axis, plotted against the new axis in accordance with an illustrative embodiment. In this plot, it is apparent that the two axes are different by slight and varying amounts at each time delay, highlighting where instabilities have occurred in the optical paths. FIG. 5D shows the drift in path length over the full length of the scan in accordance with an illustrative embodiment.

The drift shown in FIGS. 5C and 5D occurs over a range of 2 fs (equivalent to 600 nm) which is a significant amount for UV/Vis wavelengths (200 nm to 700 nm). The trace shows the propagated error for calculated values of path length difference Δx demonstrating that the path length drift lies outside the error boundaries. FIG. 5 thus proves the phase detection scheme works well to detect instabilities in the path lengths of the arms of the MZI.

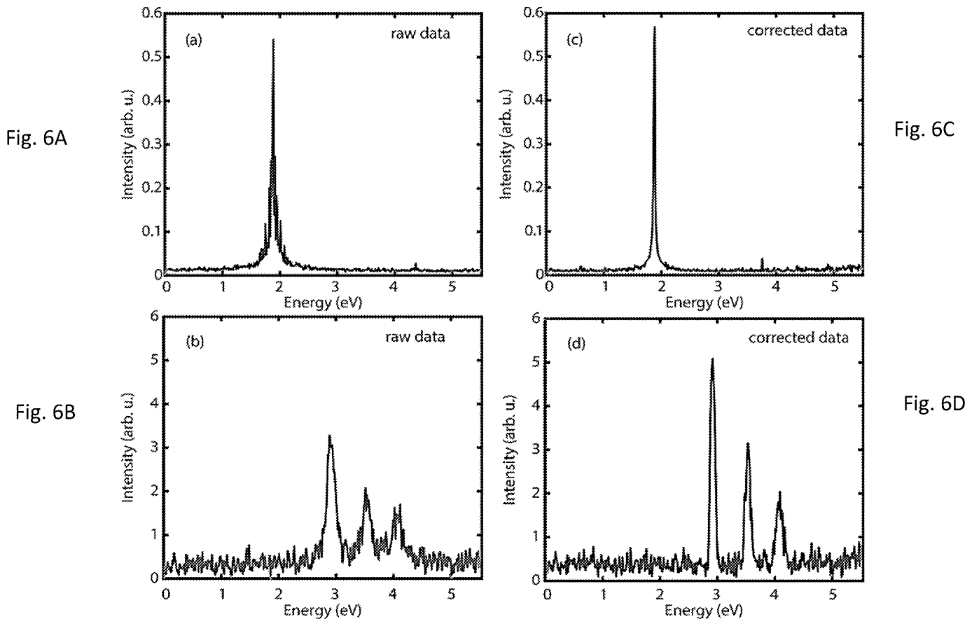

The SFG signal collected by the third channel on the lock-in amplifier plotted against the recalculated time delay axis is Fourier transformed to show the SFG spectra in FIG. 6. Specifically, FIG. 6A shows a Fourier transform of (a) the raw diode data showing the frequency of the diode at 1.89 eV in accordance with an illustrative embodiment. FIG. 6B depicts frequency domain GaAs spectra showing three peaks at 2.92 eV (second harmonic of 850 nm fundamental), 3.54 eV (SFG of 850 nm and 600 nm), and 4.09 eV (second harmonic of 600 nm) in accordance with an illustrative embodiment. FIG. 6C. shows a non-uniform Fourier transform of the phase corrected data from FIG. 6A showing narrower peaks with less noise and higher intensity in accordance with an illustrative embodiment. FIG. 6D. shows a non-uniform Fourier transform of the phase corrected data from FIG. 6B showing narrower peaks with less noise and higher intensity in accordance with an illustrative embodiment.

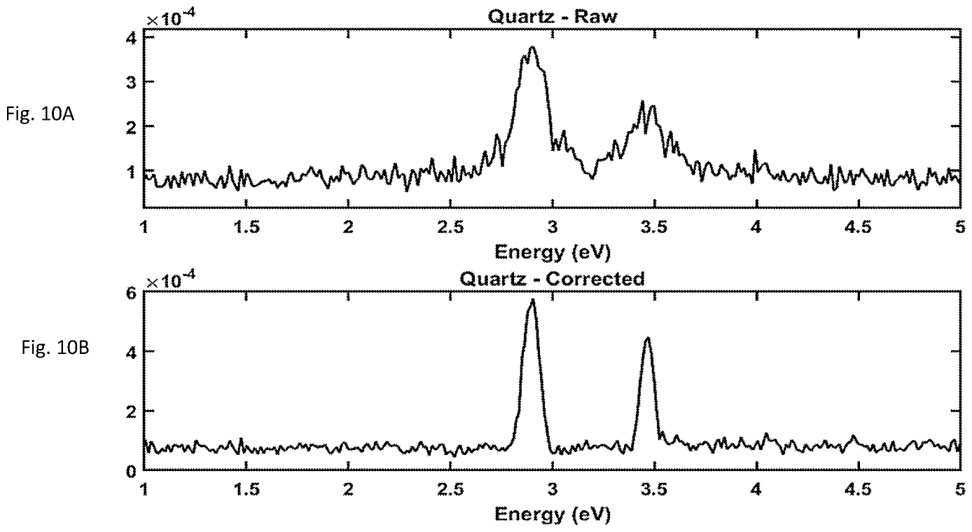

Fast Fourier transform algorithms require evenly spaced sample points for constructing the frequency axis. The original time delay axis was informed only by the steps of the mechanical stage controller, performing a regularly spaced scan, and was therefore uniform. The new axis, accounting for changes to the programmed path length change due to drifts and instabilities, is not uniform. For this irregularly spaced time delay axis, the MATLAB algorithm for Non-Uniform Fast Fourier Transform was used to compute the spectra. Traces plotted with the new time delay axis show a much higher signal to noise ratio, narrower linewidths, and more accurate position of the peaks in frequency domain, as shown in FIG. 6. These spectra show the tremendous improvement that is achieved by detecting and correcting for phase drifts with this spectrometer. The same spectra taken in the frequency domain with a spectrometer (Ocean Insight Maya2000 Pro) are shown in FIG. 10. They show the same lineshapes and frequencies as the spectra achieved with the time domain spectrometer. It is worth noting that the frequency domain spectrometer could not detect the bluest SHG color at 4.09 eV (300 nm) likely due to the quantum efficiency of the spectrometer.

Discussed below is a complete derivation of Δφ. The detected heterodyne intensity is expressed as:

I_{det}=|E_{LO}+E_{SFG}|² Equation 15:

Assuming ESFG and ELO both consist of a single frequency ω one can write I_{det}=E₁e^{i(ωt+φ}^{_{LO}}⁾+E₂e^{i(ωt+φ}^{_{SFG}}⁾|² for scalars E₁ and E₂. One then temporally modulate the local oscillator according to γ cos(νrt). This modulation can be expressed as a phase shift:

I_{det}=|E₁e^{i(ωt+φ}^{_{LO}}^{+γ cos(ν}^{ᵣ}^{t)}+E₂e^{i(ωt+φ}^{_{SFG}}⁾|²=E₁e^{iγ cos(ν}^{ᵣ}^{t)}e^{i(ωt+φ}^{_{LO}}⁾+E₂e^{i(ωt+}^{_{SFG}}⁾|². Equation 16:

One can then use the Jacobi-Anger expansion to get

$${I}_{det} = {\vert {E}_{1} {\sum }_{n = - ∞}^{∞} {i}^{n} {J}_{n} ( γ ) {e}^{{inv}_{r} t} {e}^{i ( ω t + {ϕ}_{LO} )} + {E}_{2} {e}^{i ( ω t + {ϕ}_{SFG} )} \vert}^{2} ,$$

### by Euler's Identity,

$$\begin{matrix}= {\vert {E}_{1} {\sum }_{n = - ∞}^{∞} {e}^{in π / 2} {J}_{n} ( γ ) {e}^{{inv}_{r} t} {e}^{i ( ω t + {ϕ}_{LO} )} + {E}_{2} {e}^{i ( ω t + {ϕ}_{SFG} )} \vert}^{2} \\ = {\vert {E}_{1} {\sum }_{n = - ∞}^{∞} {J}_{n} ( γ ) {e}^{{inv}_{r} t} {e}^{i ( ω t + {ϕ}_{LO} + \frac{n π}{2} )} + {E}_{2} {e}^{i ( ω t + {ϕ}_{SFG} )} \vert}^{2} \\ = ( {E}_{1} {\sum }_{n = - ∞}^{∞} {J}_{n} ( γ ) {e}^{{inv}_{r} t} {e}^{i ( ω t + {ϕ}_{LO} + \frac{n π}{2} )} \\ + {E}_{2} {e}^{i ( ω t + {ϕ}_{SFG} )} ) ( {E}_{1} {\sum }_{m = - ∞}^{∞} {J}_{m} ( γ ) {e}^{- {imv}_{r} t} {e}^{- i ( ω t + {ϕ}_{LO} + \frac{n π}{2} )} + {E}_{2} {e}^{i ( ω t + {ϕ}_{SFG} ) )} ) \\ = {E}_{1}^{2} {\sum }_{n = - ∞}^{∞} {\sum }_{m = - ∞}^{∞} {J}_{n} ( γ ) {J}_{m} ( γ ) {e}^{i ( n - m ) {v}_{r} t} {e}^{i ( n - m ) π / 2} \\ + {E}_{2}^{2} + {E}_{1} {E}_{2} {\sum }_{n = - ∞}^{∞} {J}_{n} ( γ ) {e}^{{inv}_{r} t} {e}^{i ( {ϕ}_{LO} - {ϕ}_{SFG} + \frac{n π}{2} )} \\ + {E}_{1} {E}_{2} {\sum }_{m = - ∞}^{∞} {J}_{m} ( γ ) {e}^{{imv}_{r} t} {e}^{i ( - {ϕ}_{LO} + {ϕ}_{SFG} i \frac{m π}{2} )} .\end{matrix}$$

If one lets φ_{LO}−φ_{SFG}=ΔΦ, then:

$${I}_{det} = ( {E}_{1}^{2} {\sum }_{n = - ∞}^{∞} {\sum }_{m = - ∞}^{∞} {J}_{n} ( γ ) {J}_{m} ( γ ) {e}^{i ( n - m ) {v}_{r} t} {e}^{i ( n - m ) π / 2} ) + {E}_{2}^{2} + {E}_{1} {E}_{2} {\sum }_{n = - ∞}^{∞} {J}_{n} ( γ ) ( {e}^{{inv}_{r} t} {e}^{i ( ΔΦ + \frac{n π}{2} )} + {e}^{- {inv}_{r} t} {e}^{- i ( ΔΦ + \frac{n π}{2} )} ) ) \qquad Equation 17$$

One can set the lock-in amplifier reference frequency to a particular harmonic of the mirror modulation frequency kνr. The mixed lock-in amplifier signal is then:

$$( {E}_{1}^{2} {\sum }_{n = - ∞}^{∞} {\sum }_{m = - ∞}^{∞} {J}_{n} ( γ ) {J}_{m} ( γ ) {e}^{i ( n - m ) {v}_{r} t} {e}^{i ( n - m ) π / 2} ) {e}^{- {ikv}_{r} t} + \text{} {E}_{2}^{2} {e}^{- {ikv}_{r} t} + {E}_{1} {E}_{2} ( {\sum }_{n = - ∞}^{∞} {J}_{n} ( γ ) ( {e}^{{inv}_{r} t} {e}^{i ( ΔΦ + \frac{n π}{2} )} {e}^{- {inv}_{r} t} {e}^{- i ( ΔΦ + \frac{n π}{2} )} ) ) ) {e}^{- {inv}_{r} t} \qquad Equation 18$$

The lock-in amplifier then applies a low pass filter such that only terms with frequencies near 0 remain. For the first term, the frequency is 0 when n−m=k, and for the last term it is 0 when n=±k. The second term is always eliminated unless the mirror vibration frequency νr=0. Equation 18 then reduces to:

$${E}_{1}^{2} {\sum }_{m = - ∞}^{∞} {J}_{m + k} ( γ ) {J}_{m} ( γ ) {e}^{ik π / 2} + {E}_{1} {E}_{2} ( {J}_{k} ( γ ) {e}^{i ( ΔΦ + \frac{k π}{2} )} + {J}_{- k} ( γ ) {e}^{- i ( ΔΦ + \frac{- k π}{2} )} ) = {E}_{1}^{2} {\sum }_{m = - ∞}^{∞} {J}_{m + k} ( γ ) {J}_{m} ( γ ) {e}^{i k π / 2} + {E}_{1} {E}_{2} ( {J}_{k} ( γ ) ( {e}^{i ( ΔΦ + \frac{k π}{2} )} + {( - 1 )}^{k} {e}^{- i ( ΔΦ + \frac{- k π}{2} )} ) ) \qquad ( S5 )$$

By Neumann's Addition Theorem, Σ_{m=-∞}^{∞}Jₘ₊ₖ(γ)Jₘ(γ)=Jₖ(γ−γ)=Jₖ(0)=δ₀ₖ. The first term in equation 19 therefore goes to 0 for all non-zero values of k. Equation 19 then reduces to:

$${E}_{1} {E}_{2} {J}_{k} ( γ ) ( {e}^{i ( Δ Φ + \frac{k π}{2} )} + {( - 1 )}^{k} {e}^{- i ( Δ Φ + \frac{- k π}{2} )} ) \qquad Equation 20$$

One can collect only the real part of our demodulated signal. Taking the real part of Equation 20 yields:

$${E}_{1} {E}_{2} {J}_{k} ( γ ) ( cos ( Δ Φ + \frac{k π}{2} ) + {( - 1 )}^{k} cos ( Δ Φ - \frac{k π}{2} ) ) \qquad Equation 21$$

For odd k:

−2E₁E₂J_{K}(γ)sin(ΔΦ),k≡1(mod 4)

2E₁E₂J_{K}(γ)sin(ΔΦ),k≡3(mod 4).
For even k:

2E₁E₂Jₖ(γ)cos(ΔΦ),k≡0(mod 4)

−2E₁E₂Jₖ(γ)cos(ΔΦ),k≡2(mod 4).

Taking the ratio of the demodulated signals when locking in to harmonics 3 and 2 yields:

$$\frac{2 {E}_{1} {E}_{2} {J}_{3} ( γ ) sin ( Δ Φ )}{- 2 {E}_{1} {E}_{2} {J}_{2} ( γ ) cos ( Δ Φ )} = \frac{{J}_{3} ( γ )}{{J}_{2} ( γ )} tan ( Δ Φ )$$

Since γ is known, one can use this quantity to calculate Δφ.

Mirror modulation depth is discussed below. Equation (8) shows Uₘ∝Jₘ(γ). By locking in to the m^{th} harmonic of the mirror modulation frequency νᵣ, one expects to get a signal proportional to the m^{th} order Bessel function evaluated at γ. The value of γ can be expressed in terms of the displacement amplitude of the mirror

$$Δ l as \frac{4 πΔ l}{λ} .$$

The value of the Bessel function evaluated at a particular Δl and λ is oscillatory, with some values of ΔL and λ yielding larger values of Jₘ (γ). In order to achieve the best possible signal to noise, a value for Δl was selected that yields a relatively large Jₘ (γ) for the/values of interest. In this case, a displacement amplitude of 51 nm was selected, as this value yields strong Bessel function values for the desired wavelengths.

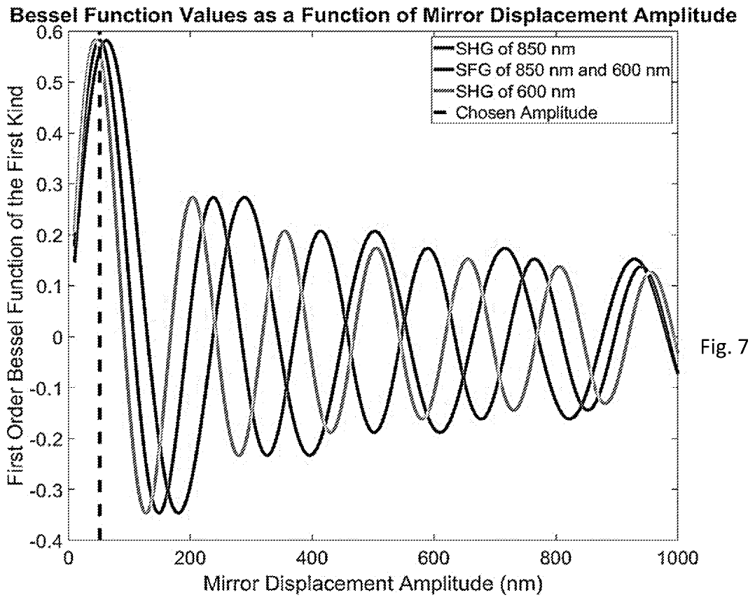

FIG. 7 shows Bessel function values as a function of mirror modulation amplitude for various relevant wavelengths in accordance with an illustrative embodiment. The inventors chose a mirror modulation amplitude that yields large Bessel function values for all relevant wavelengths. For this experiment, 51 nm is near the maximum for all relevant wavelengths. The inventors therefore used a 51 nm modulation amplitude for this experiment.

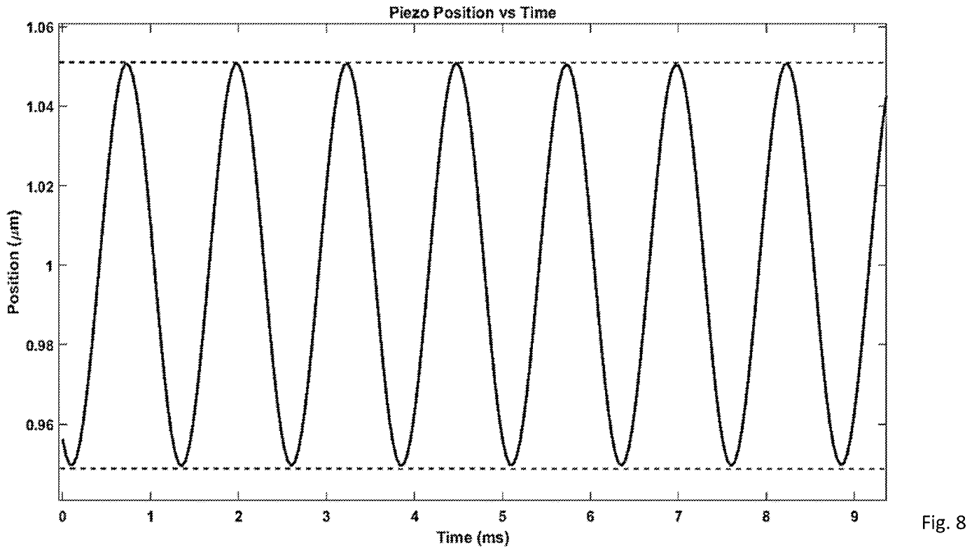

In an illustrative embodiment, the displacement of the vibrating mirror is due to a piezo element (e.g., Physik Instrumente S-303) that is controlled by Physik Instrumente Mikromove or another source. FIG. 8 shows the reported position of the piezo of the vibrating mirror as a function of time, determined using capacitive sensing in accordance with an illustrative embodiment. In FIG. 8, dashed lines denote displacement by ±51 nm.

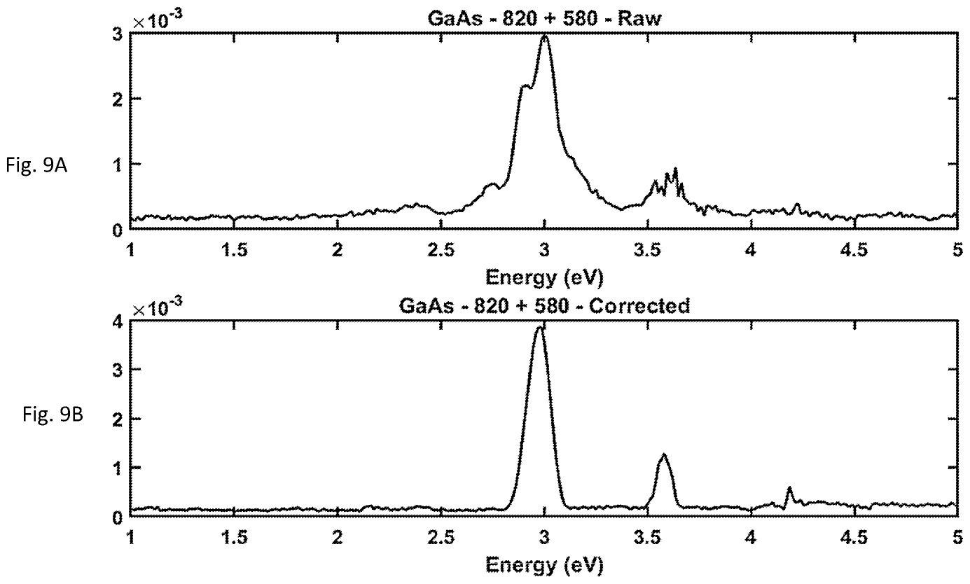

The inventors were able to obtain spectra using several different fundamental wavelengths. The raw and corrected spectra are shown in FIG. 9. FIG. 9A depicts raw spectra data obtained at different fundamental wavelengths in accordance with an illustrative embodiment. FIG. 9B depicts corrected spectra data obtained at different fundamental wavelengths in accordance with an illustrative embodiment. FIG. 9 shows SFG spectra obtained with GaAs as both LO source and sample when irradiated with 820 nm and 580 nm light before and after phase correction. Peaks are noisy and artificially broadened in the uncorrected spectrum as compared to the corrected spectrum.

The inventors were also able to obtain spectra with z-cut quartz in the sample position and GaAs as the LO source. The raw and corrected spectra are shown in FIG. 10. FIG. 10A depicts raw spectra data from z-cut quartz in the sample position and GaAs as the LO source in accordance with an illustrative embodiment. FIG. 10B depicts corrected spectra data from z-cut quartz in the sample position and GaAs as the LO source in accordance with an illustrative embodiment. FIG. 10 shows SFG spectra obtained with GaAs as the LO source and z-cut quartz as the sample irradiated with 600 nm and 850 nm light before and after phase correction. The OPA output is weaker at 600 nm than 580 nm, and so the SHG of 600 nm is not strong enough to be visible.

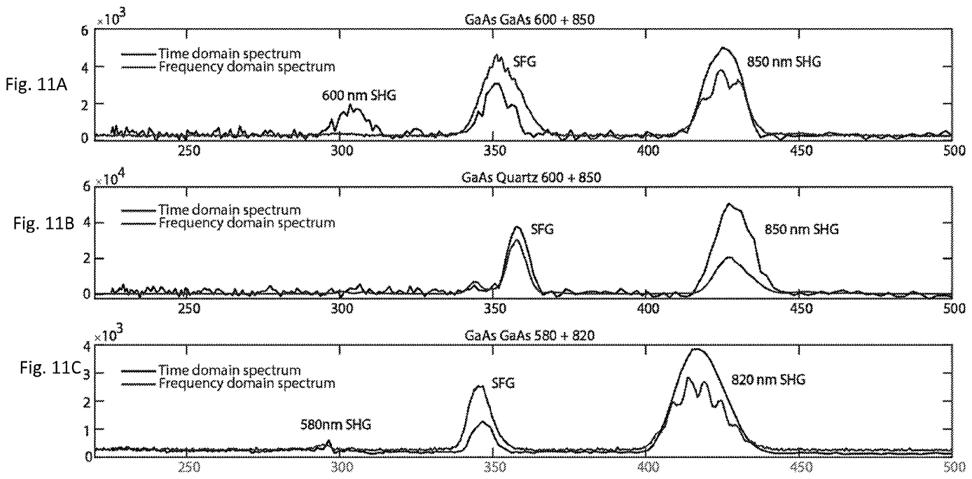

Spectra were collected on a traditional, frequency domain spectrometer (e.g., Ocean Insight Maya2000 Pro) in addition to the time domain spectrometer. FIG. 11A shows spectra corresponding to FIG. 6D collected with a traditional frequency domain spectrometer in accordance with an illustrative embodiment. FIG. 11B shows spectra corresponding to FIG. 10 collected with a traditional frequency domain spectrometer in accordance with an illustrative embodiment. FIG. 11C shows spectra corresponding to FIG. 9 collected with a traditional frequency domain spectrometer in accordance with an illustrative embodiment. It is notable that the shortest wavelength peaks (SHG of 580 nm or 600 nm) are not at all or barely visible in these spectra, as the spectrometer sensitivity is lower than in the above-discussed time domain collection scheme. Linewidths and lineshapes are in good agreement between different detection methods.

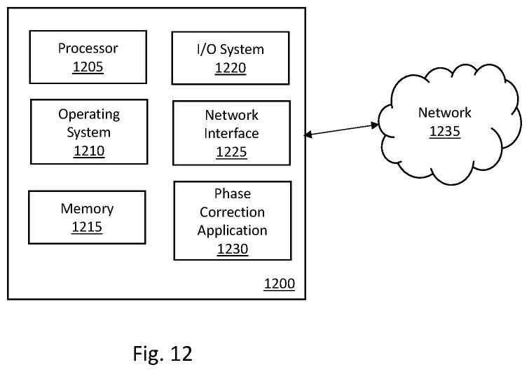

In an illustrative embodiment, any of the operations described herein can be performed by a computing system that includes a processor, a memory, a user interface, a transceiver, etc. The memory can be used to stored computer-readable instructions that, upon execution by the processor, cause the computing system to perform the operations described herein. As an example, FIG. 12 is a block diagram of a computing system 1200 to implement a phase correction system in accordance with an illustrative embodiment. The computing system 1200 can communicate directly with other computing devices (e.g., servers, processors, etc.), or through a network 1235, depending on the implementation.

The computing system 1200 includes a processor 1205, an operating system 1210, a memory 1215, an input/output (I/O) system 1220, a network interface 1225, and a phase correction application 1230. In alternative embodiments, the computing system 1200 may include fewer, additional, and/or different components. The components of the computing system 1200 communicate with one another via one or more buses or any other interconnect system. The computing system 1200 can be any type of computing device (e.g., tablet, laptop, desktop, etc.) that has sufficient processing power to perform the operations described herein. In one embodiment, the computing system 1200 can be incorporated as part of a spectrometer.

The processor 1205 can be in electrical communication with and used to control any of the system components described herein. For example, the processor can be used to execute the phase correction application 1230, process received user selections, send data and commands to the external devices, receive raw data from a spectrometer, process the data using the algorithms described herein, etc. The processor 1205 can be any type of computer processor known in the art, and can include a plurality of processors and/or a plurality of processing cores. The processor 1205 can include a controller, a microcontroller, an audio processor, a graphics processing unit, a hardware accelerator, a digital signal processor, etc. Additionally, the processor 1205 may be implemented as a complex instruction set computer processor, a reduced instruction set computer processor, an x86 instruction set computer processor, etc. The processor 1205 is used to run the operating system 1210, which can be any type of operating system.

The operating system 1210 is stored in the memory 1215, which is also used to store programs, user data, spectrometer readings and settings, network and communications data, peripheral component data, the phase correction application 1230, and other operating instructions. The memory 1215 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc. In some embodiments, at least a portion of the memory 1215 can be in the cloud to provide cloud storage for the system. Similarly, in one embodiment, any of the computing components described herein (e.g., the processor 1205, etc.) can be implemented in the cloud such that the system can be run and controlled through cloud computing.

The I/O system 1220 is the framework which enables users and peripheral devices to interact with the computing system 1200. The I/O system 1220 can include a display, one or more speakers, one or more microphones, a keyboard, a mouse, one or more buttons or other controls, etc. that allow the user to interact with and control the computing system 1200. The I/O system 1220 also includes circuitry and a bus structure to interface with peripheral computing devices such as power sources, universal service bus (USB) devices, data acquisition cards, peripheral component interconnect express (PCIe) devices, serial advanced technology attachment (SATA) devices, high definition multimedia interface (HDMI) devices, proprietary connection devices, etc.

The network interface 1225 includes transceiver circuitry (e.g., a transmitter and a receiver) that allows the computing device 1200 to transmit and receive data to/from other devices such as a remote data processing center, other remote computing systems, servers, websites, etc. The network interface 1225 enables communication through the network 1235, which can be one or more communication networks. The network 1235 can include a cable network, a fiber network, a cellular network, a wi-fi network, a landline telephone network, a microwave network, a satellite network, etc. The network interface 1225 also includes circuitry to allow device-to-device communication such as Bluetooth® communication.

The phase correction application 1230 can include software and algorithms in the form of computer-readable instructions which, upon execution by the processor 1205, performs any of the various operations described herein such as controlling light sources, receiving measured data, analyzing the data to determine phase shifts, applying a correction to the data based on the phase shifts, etc. The phase correction application 1230 can utilize the processor 1205 and/or the memory 1215 as discussed above. In an alternative implementation, the phase correction application 1230 can be remote or independent from the computing system 1200, but in communication therewith.

An error analysis is included below. The Δφ equation is:

$$Δ Φ = arctan \frac{{U}_{m} {J}_{n} [ γ ]}{{U}_{n} {J}_{m} [ γ ]} \qquad Equation 22$$

The uncertainty formula for Δφ is:

$$( S9 )$$

$$σ Δ Φ = \frac{\partial Δ Φ}{\partial {U}_{m}} ( σ {U}_{m} ) + \frac{\partial Δ Φ}{\partial {U}_{n}} ( σ {U}_{n} ) + \frac{\partial Δ Φ}{\partial {J}_{m} ⌈ γ ⌉} ( σ {J}_{m} [ γ ] ) + \frac{\partial Δ Φ}{\partial {J}_{n} ⌈ γ ⌉} ( σ {J}_{n} [ γ ] )$$

The partial derivatives are:

$$\frac{\partial Δ Φ}{\partial {U}_{m}} = \frac{{U}_{n} {J}_{m} [ γ ] {J}_{n} [ γ ]}{{( {U}_{n} {J}_{m} [ γ ] )}^{n} + {( {U}_{m} {J}_{n} [ γ ] )}^{n}}$$

$$\frac{\partial Δ Φ}{\partial {U}_{n}} = - \frac{{U}_{m} {J}_{m} [ γ ] {J}_{n} [ γ ]}{{( {U}_{n} {J}_{m} [ γ ] )}^{n} + {( {U}_{m} {J}_{n} [ γ ] )}^{n}}$$

$$\frac{\partial Δ Φ}{\partial {J}_{m} [ γ ]} = - \frac{{U}_{m} {U}_{n} {J}_{n} [ γ ]}{{( {U}_{n} {J}_{m} [ γ ] )}^{n} + {( {U}_{m} {J}_{n} [ γ ] )}^{n}}$$

$$\frac{\partial Δ Φ}{\partial {J}_{n} [ γ ]} = \frac{{U}_{m} {U}_{n} {J}_{n} [ γ ]}{{( {U}_{n} {J}_{m} [ γ ] )}^{n} + {( {U}_{m} {J}_{n} [ γ ] )}^{n}}$$

The value for σUₘ is taken as the variance of the power of the diode as a percentage of its mean power at 0.000176. This is an upper bound on the error as it is expected that any intensity fluctuations would be cancelled out in calculating the ratio Um/Un. Values for ∂Jₘ [γ] are calculated as follows:

Calculating error in γ:

$$γ = \frac{4 πΔ L}{λ} \qquad Equation 24$$

$$σγ = \frac{4 π}{λ} ( σΔ L ) - \frac{4 πΔ L}{{λ}^{2}} ( σ λ ) \qquad Equation 25$$

Error in ΔL (taken as the Bidirectional repeatability error reported by Physik Instrumente) is 1.4 nm, and error in wavelength is the FWHM of spectrum, 0.84 nm.

$$Calculating \partial J [ γ ] :$$

$$\partial {J}_{m} [ γ ] = \frac{\partial {J}_{m} [ γ ]}{\partial γ} ( σ γ )$$

$$\frac{\partial {J}_{m} [ γ ]}{\partial γ} = \frac{1}{2} ( {J}_{m - 1} [ γ ] + {J}_{m + 1} [ γ ] )$$

The inventors used m=2 and m=3 in the data.

Error for path length difference Δx:

$$Δ x = \frac{Δ ϕ}{2 π} λ + n λ \qquad Equation 26$$

$$σΔ x = \frac{λ}{2 π} ( σ Δ ϕ ) + ( \frac{Δ ϕ}{2 π} + n ) ( σ λ ) \qquad Equation 27$$

In the calculation for σΔx, σλ is taken to be zero. Calculated σΔx is in nm and is converted to fs by dividing by the speed of light. The largest source of error was found to be the fluctuations in intensity of the reference diode. The calculated error is expected to be an overestimate for two reasons. First, the simultaneous and instantaneous data collection at all lock-in amplifier channels means any instabilities due source intensity fluctuations would be expected to be the same for each channel in the lock-in amplifier and therefore cancelled out in computing the U2 ratio. Second, the lock-in amplifier filters out noise that is not on the frequency of its reference signal (i.e. harmonics of the vibration frequency).

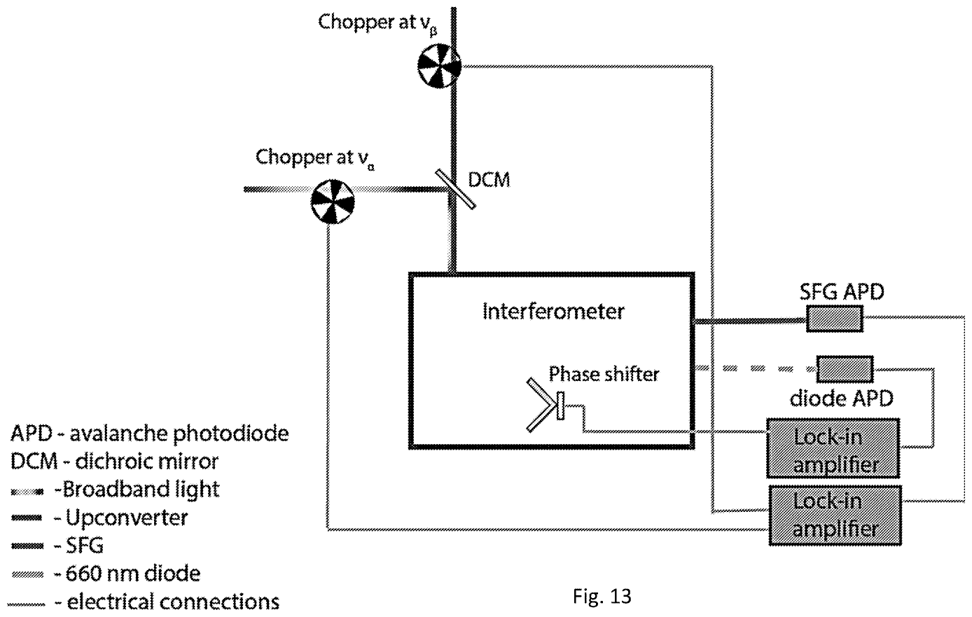

In another embodiment, the proposed instrument can be expanded to include the use of a broadband white light probe light. To simplify the analysis of the resulting broadband SFG spectrum, the inventors have added a scheme to separate the overlapping peaks resulting from second harmonic generation (SHG) and SFG of the broadband white light. FIG. 13 depicts a system that utilizes a broadband white light probe in accordance with an illustrative embodiment. As shown, in this embodiment, new components have been added to the system. The new components include a broadband white light source, a chopper (or modulator) positioned in each of the broadband white light path and the narrowband upconverter light path, and a second lock-in amplifier unit. Specifically, the second lock-in amplifier is incorporated into the system, in sync with the first lock-in amplifier. As also shown, a first chopper modulates the intensity of the white light probe with frequency ν₁, and a second chopper modulates the intensity of the upconverter line with frequency ν₂. As a result, the intensity of the SFG light is modulated with frequency ν₁+ν₂. Locking into this frequency, the second lock-in amplifier is used only to amplify the SFG peaks, removing the SHG peaks from the spectrum. The first lock-in amplifier can be used for phase detection as before.

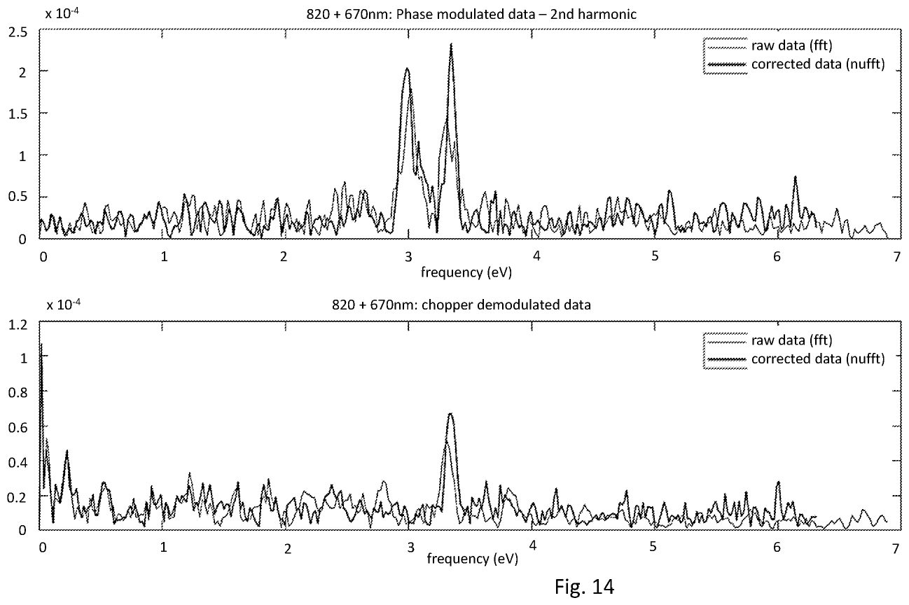

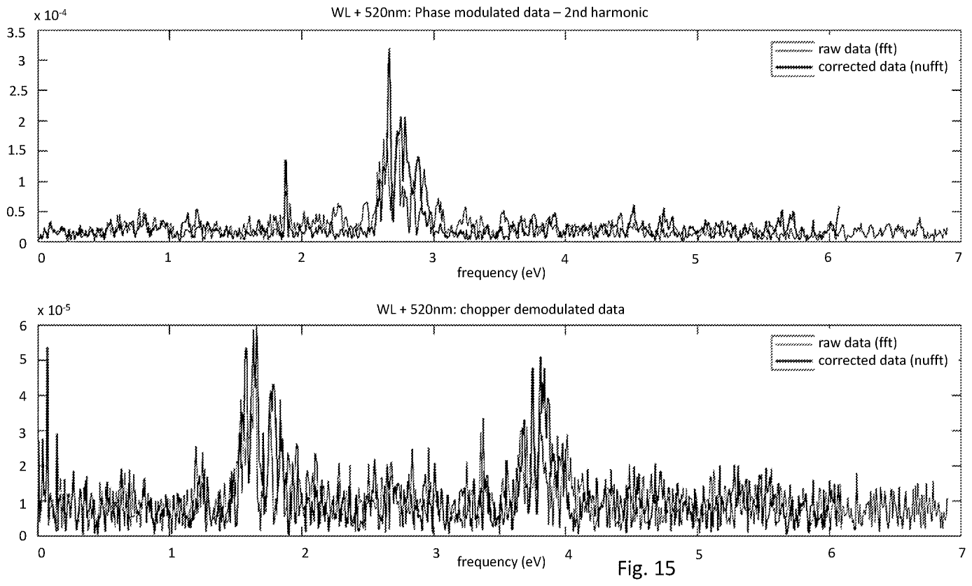

FIG. 14 shows proof of principle experiment results for phase correction with the chopper and two lock in amplifier scheme of FIG. 13 in accordance with an illustrative embodiment. The experiments were conducted using narrowband light at 820 nm and 670 nm. The top panel of FIG. 14 shows spectra from set up with one lock-in amplifier and no choppers for comparison. The bottom panel is the spectrum of two lock-in amplifier scheme and two choppers. As shown, there is only a single SFG peak present, with all other peaks eliminated. FIG. 15 shows a comparison of the two schemes with broadband light in accordance with an illustrative embodiment. In the bottom panel of FIG. 15, the weaker broadband SFG light around 4 eV is more clearly present.

Thus, the inventors have developed a new design for phase-sensitive detection of electronic sum frequency generation spectra. By using continuous phase modulation of the local oscillator in the time domain the system is able to measure the relative phase between the local oscillator and the SFG signal. This enables the system to account for any phase drifts arising from instabilities in the optical set-up, resulting in much higher SNR, correct lineshapes, and spectral accuracy in SFG spectra.

Phase stability in the spectra facilitates heterodyning to achieve simultaneous detection of phase and amplitude. Heterodyne detection decouples real and imaginary parts of the detected SFG electric field, which will afford accurate spectra, eliminate non-resonant contributions, and elucidate the orientation of molecules at the interface. Slow phase drifts that distort phase-sensitive data over long scans are corrected through directly measuring the relative phase difference between LO and SFG signals and translating it into a new, more accurate time delay axis. Time-domain detection allows for more accurate SFG spectra with high frequency resolution while taking advantage of more sensitive and cost-effective single channel detectors. Collinear geometry of the two fundamentals E_{Vis} and E_{NIR} leads to a smaller room for error in the phase of reference with respect to the sample, such that normalizing the sample spectrum by the reference spectrum will yield accurate phase and amplitude for χ⁽²⁾.

This spectrometer design will revolutionize the study of buried interfaces by paving the way for time-resolved phase-sensitive experiments without risking compromising the data due to phase drifts over time. As discussed, some iterations of this spectrometer are able to take advantage of a broadband white light source along with a NIR E₂ pulse to probe multiple resonances at once, providing a wealth of data with each scan. The methods described herein and the relevant signal processing can be more broadly applied to any interferometric measurements that require high phase stability, breaking ground for more innovative spectroscopic techniques in the visible and ultraviolet regions.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. An interferometric measurement system comprising:
a first light source that interacts with a sample to generate sum frequency generated (SFG) light;
a second light source and a crystal that generates a local oscillator (LO) beam of light that interferes with the SFG light to produce a LO/SFG interference signal;
a mirror that includes a vibrating element which causes the mirror to vibrate at a frequency, wherein the mirror receives the LO beam of light and modulates a phase of the LO/SFG interference signal between the LO beam of light and the SFG light;
a lock-in amplifier that is locked into the frequency of vibration of the mirror such that the lock-in amplifier receives the LO/SFG interference signal which has been modulated at the frequency;
a first avalanche photodiode that detects the LO/SFG interference signal;
a processor in communication with one or more of the light source, the local oscillator, the lock-in amplifier, and the first avalanche photodiode, wherein the processor is configured to:
detect, based at least in part on data from the lock-in amplifier, a relative phase between the LO beam of light and the SFG light;
correct a pathlength difference between the LO beam of light and the SFG light based at least in part on the relative phase; and
apply the corrected pathlength difference to the LO/SFG interference signal to correct for phase variation that occurs during a measurement.

2. The interferometric measurement system of claim 1, further comprising a third light source that generates a reference beam of light which travels collinearly with the LO/SFG interference signal.

3. The interferometric measurement system of claim 2, wherein the reference beam of light has an opposite polarization to the LO beam of light and the SFG light.

4. The interferometric measurement system of claim 1, further comprising a second avalanche photodiode detector configured to detect a reference beam of light that travels collinearly with the LO/SFG interference signal.

5. The interferometric measurement system of claim 4, wherein the lock-in amplifier receives outputs from the first avalanche photodiode and the second avalanche photodiode.

6. The interferometric measurement system of claim 1, further comprising one or more dichroic mirrors to separate an ultraviolet sum frequency generation (SFG) signal from visible and near infrared fields of the first light source.

7. The interferometric measurement system of claim 1, wherein the lock-in amplifier receives data on three channels, wherein data from a reference continuous wave diode beam of light forms an input to a first channel and a second channel of the lock-in amplifier, and wherein the SFG/LO interference signal forms an input to a third channel of the lock-in amplifier.

8. The interferometric measurement system of claim 7, wherein the first channel of the lock-in amplifier receives is locked into a second harmonic of the frequency at which the mirror vibrates.

9. The interferometric measurement system of claim 7, wherein the second channel of the lock-in amplifier is locked into a third harmonic of the frequency at which the mirror vibrates.

10. The interferometric measurement system of claim 7, wherein the third channel of the lock-in amplifier is locked into a second harmonic of the frequency at which the mirror vibrates.

11. A method for performing interferometric measurements, the method comprising:
generating, by light from a first light source that interacts with a sample, a sum frequency generated (SFG) light;
generating, by a second light source and a crystal, a local oscillator (LO) beam of light that interferes with the SFG light to produce a LO/SFG interference signal;
vibrating, at a frequency, a mirror that receives the LO beam of light and modulates a phase of the LO/SFG interference signal;
receiving, by a lock-in amplifier that is locked into the frequency of vibration of the mirror, the LO/SFG interference signal which has been modulated at the frequency;
detecting the LO/SFG interference signal by a first avalanche photodiode;
detecting, by a processor and based at least in part on data from the lock-in amplifier, a relative phase between the LO beam of light and the SFG light;
correcting, by the processor, a pathlength difference between the LO beam of light and the SFG light based at least in part on the relative phase; and
applying, by the processor, the corrected pathlength difference to the LO/SFG interference signal to correct for phase variation that occurs during a measurement.

12. The method of claim 11, further comprising generating, by a third light source, a reference beam of light which travels collinearly with the LO/SFG interference signal.

13. The method of claim 12, further comprising receiving, by a first avalanche photodiode, a first signal based on the reference beam.

14. The method of claim 13, further comprising receiving, by a first channel of the lock-in amplifier, the first signal based on the reference beam, wherein the first channel of the lock-in amplifier is locked into a second harmonic of the frequency at which the mirror vibrates.

15. The method of claim 11, further comprising receiving, by a second avalanche photodiode, a sum frequency generation (SFG) signal based at least in part on the SFG light.

16. The method of claim 15, further comprising receiving, by a third channel of the lock-in amplifier, the SFG signal from the first avalanche photodiode, wherein the third channel of the lock-in amplifier is locked into a second harmonic of the frequency at which the mirror vibrates.

17. An interferometric measurement system comprising:
a broadband white light source that interacts with an upconverter light source and a chemical sample to generate broadband sum frequency generated (SFG) light;
a first chopper that modulates an intensity of light from the broadband light source at a first frequency;
a second chopper that modulates an intensity of light from the upconverter light source at a second frequency that differs from the first frequency;
a local oscillator light source and a crystal that generates a local oscillator (LO) beam of light that interferes with the broadband SFG light to produce an LO/SFG interference signal;
a mirror that includes a vibrating element which causes the mirror to vibrate at a frequency, wherein the mirror receives the LO beam of light and modulates a phase of the LO/SFG interference signal;
a first lock-in amplifier that is locked into the frequency of vibration of the mirror such that the first lock-in amplifier receives a reference wave which has been modulated at the frequency;
a second lock in amplifier that is locked into a sum of the frequencies of the first chopper and the second chopper, and wherein the second lock-in amplifier receives the LO/SFG interference signals that is also modulated by the first chopper and the second chopper; and
a processor in communication with the first lock-in amplifier and the second lock-in amplifier, wherein the processor is configured to:
detect, based at least in part on data from one or more of the first lock-in amplifier and the second lock-in amplifier, a relative phase between the LO light and the broadband SFG light;
correct a pathlength difference between the LO light and the broadband SFG light based at least in part on the relative phase; and
apply the corrected pathlength difference to the LO/SFG interference signal to correct for phase variation that occurs during a measurement.

18. (canceled)

19. The system of claim 17, wherein the reference wave travels collinearly with the LO/SFG interference signal.

20. The system of claim 17, wherein the reference wave has an opposite polarization to the LO beam of light and the broadband SFG light.

21. (canceled)

22. The system of claim 17, wherein the first lock-in amplifier receives data on three channels, wherein data from the reference wave forms an input to a first channel and a second channel of the first lock-in amplifier

23. (canceled)

24. (canceled)

25. (canceled)

26. (canceled)
